(19) United States
(12) Patent Application Publication
(10) Pub. No.: US 2011/0016993 A1
(43) Pub. Date: Jan. 27, 2011

(54) CLIP FOR DETECTING WINDOW GLASS BREAKAGE

(75) Inventor: Tsuneo Suzuki, Kariya-shi (JP)

Correspondence Address: GREENBLUM & BERNSTEIN, P.L.C., 1950 ROLAND CLARKE PLACE, RESTON, VA, 20191, US

(73) Assignee: KABUSHIKI KAISHA TOYOTA JIDOSHOKKI, Aichi-ken (JP)

(21) Appl. No.: 12/933,098

(22) PCT Filed: Apr. 30, 2009
(86) PCT No.: PCT/JP2009/058452

§ 371 Date: Sep. 17, 2010

(30) Foreign Application Priority Data
May 22, 2008 (JP) 2008-134328

(51) Int. Cl. G01M 99/00; B60R 25/00

(52) U.S. Cl. 73/865.8

(57) ABSTRACT

A clip for detecting window glass breakage used to detect breakage of a window glass when the arrangement state of a detected member relative to a window glass of a vehicle changes. The clip for detecting window glass breakage includes first and second members bent toward each other to hold an end portion of the window glass. When the window glass is unbroken, the first member and the second member contact the window glass at different positions in a plane of the window glass and are urged toward each other in a state in which the window glass is arranged therebetween. When the window glass is broken, the first member and the second member are elastically deformed so as to shatter the end portion of the window glass and thereby change the arrangement state of the detected member relative to the window glass.

### FIELD OF THE INVENTION

The present invention relates to a clip for detecting window glass breakage.

### BACKGROUND OF THE INVENTION

Patent Document 1 discloses a device that detects breakage of a window glass of a vehicle to prevent theft. As shown in FIG. 30, a window glass 200 is supported by a carrier plate 211 of a cable type window regulator 210. The device includes a compression coil spring 220 that urges the carrier plate 211 in a closing direction of the window glass 200 when the window glass 200 is located at a fully-closed position where it closes a window opening. Breakage of the window glass 200 releases the engagement of a stopper pin 205, which is arranged on the window glass 200, and a hook 206, which is arranged on the vehicle body. Then, the compression coil spring 220 further moves the window glass 200 in the closing direction from the fully-closed position. A limit switch 230 detects the movement of the carrier plate 211 and thereby detects breakage of the window glass.

Reinforced glass is normally used as the window glass 200. The application of an impact breaks the window glass into pieces. However, part of the window glass may hold together without being shattered. When the window glass 200 holds together near the carrier plate 211, the carrier plate 211 may not move in the closing direction in which case breakage of the window glass 200 would not be detected. [Patent Document 1] Japanese Laid-Open Patent Publication No. 11-321564

### SUMMARY OF THE INVENTION

It is an object of the present invention to provide a clip for detecting window glass breakage that ensures detection of window glass breakage even if the window glass holds together and is not completely shattered when the window is broken.

To achieve the above object, one aspect of the present invention is a clip for detecting window glass breakage used to detect breakage of a window glass when the arrangement state of a detected member relative to a window glass of a vehicle changes. The clip for detecting window breakage includes first and second members bent toward each other to hold an end portion of the window glass. When the window glass is unbroken, the first member and the second member contact the window glass at different positions in a plane of the window glass and are urged toward each other in a state in which the window glass is arranged therebetween. When the window glass is broken, the first member and the second member are elastically deformed so as to shatter the end portion of the window glass and thereby change the arrangement state of the detected member relative to the window glass.

### BRIEF DESCRIPTION OF THE DRAWINGS

FIG. 1 is an exploded perspective view showing a right front door of a vehicle to which breakage detectors according to first to third embodiments of the present invention are applied;

FIG. 2 is a schematic front view showing the right front door of FIG. 1;

FIG. 3 is a cross-sectional view taken along line 3-3 in FIG. 2;

FIG. 4 is a perspective view showing the breakage detector according to the first embodiment of the present invention and including a clip and sensor unit;

FIG. 5(a) is a front view showing the clip of FIG. 4, FIG. 5(b) is a plan view, and FIG. 5(c) is a side view;

FIG. 6(a) is a cross-sectional view of the clip taken along line 6a-6a in FIG. 5(a), and FIG. 6(b) is a cross-sectional view of the clip taken along line 6b-6b in FIG. 5(a);

FIG. 7(a) is a cross-sectional view of the clip taken along line 7a-7a in FIG. 5(a), FIG. 7(b) is a cross-sectional view taken along line 7b-7b in FIG. 5(a);

FIG. 8(a) is a front view showing the clip of FIG. 4, FIG. 8(b) is a plan view, and FIG. 8(c) is a side view;

FIG. 9(a) is a front view showing the clip of FIG. 4, FIG. 9(b) is a plan view, and FIG. 9(c) is a side view;

FIG. 10(a) is a cross-sectional view taken along line 10a-10a in FIG. 9(a), and FIG. 10(b) is a cross-sectional view taken along line 10b-10b in FIG. 9(a);

FIG. 11(a) is a cross-sectional view taken along line 11a-11a in FIG. 9(a), and FIG. 11(b) is a cross-sectional view taken along line 11b-11b in FIG. 9(a);

FIG. 12 is an output characteristics diagram of the magnetic sensors shown in FIG. 3;

FIG. 13 is a characteristics diagram of the sum of the outputs of the two magnetic sensors shown in FIG. 3;

FIG. 14 is a perspective view showing the breakage detector according to the second embodiment of the present invention and including a clip and sensor unit;

FIG. 15(a) is a rear view showing the clip of FIG. 14, FIG. 15(b) is a plan view, and FIG. 15(c) is a side view;

FIG. 16(a) is a cross-sectional view taken along line 16a-16a in FIG. 15(a), FIG. 16(b) is a cross-sectional view taken along line 16b-16b in FIG. 15(a), FIG. 16(c) is a cross-sectional view taken along line 16c-16c in FIG. 15(a), and FIG. 16(d) is a cross-sectional view taken along line 16d-16d in FIG. 15(a);

FIG. 17(a) is a cross-sectional view taken along line 17a-17a in FIG. 15(a), FIG. 17(b) is a cross-sectional view taken along line 17b-17b in FIG. 15(a), FIG. 17(c) is a cross-sectional view taken along line 17c-17c in FIG. 15(a), and FIG. 17(d) is a cross-sectional view taken along line 17d-17d in FIG. 15(a);

FIG. 18(a) is a rear view showing the clip of FIG. 14, FIG. 18(b) is a plan view, and FIG. 18(c) is a side view;

FIG. 19(a) is a rear view showing the clip of FIG. 14, FIG. 19(b) is a plan view, and FIG. 19(c) is a side view;

FIG. 20(a) is a rear view showing the clip of FIG. 14, FIG. 20(b) is a plan view, and FIG. 20(c) is a side view;

FIG. 21 is a perspective view showing the breakage detector according to the third embodiment of the present invention and including a clip and sensor unit;

FIG. 22(a) is a rear view showing the clip of FIG. 21, FIG. 22(b) is a plan view, and FIG. 22(c) is a side view;

FIG. 23(a) is a cross-sectional view taken along line 23a-23a in FIG. 22(a), FIG. 23(b) is a cross-sectional view taken along line 23b-23b in FIG. 22(a), FIG. 23(c) is a cross-sectional view taken along line 23c-23c in FIG. 22(a), and FIG. 23(d) is a cross-sectional view taken along line 23d-23d in FIG. 22(a);

FIG. 24(a) is a cross-sectional view taken along line 24a-24a in FIG. 22(a), and FIG. 24(b) is a cross-sectional view taken along line 24b-24b in FIG. 22(a);

FIG. 25 is a perspective view showing a magnet of FIG. 21 from the rear;

FIG. 26(a) is a rear view showing the clip of FIG. 21, FIG. 26(b) is a plan view, and FIG. 26(c) is a side view;

FIG. 27(a) is a rear view showing the clip of FIG. 21, FIG. 27(b) is a plan view, and FIG. 27(c) is a side view;

FIG. 28(a) is a rear view showing the clip of FIG. 21, FIG. 28(b) is a plan view, and FIG. 28(c) is a side view;

FIG. 29 is a characteristics diagram of the sum of the outputs of the two magnetic sensors shown in FIG. 21; and

FIG. 30 is a front view showing a prior art detection device.

### DETAILED DESCRIPTION OF THE PREFERRED EMBODIMENTS

A first embodiment of the present invention will now be discussed with reference to the drawings.

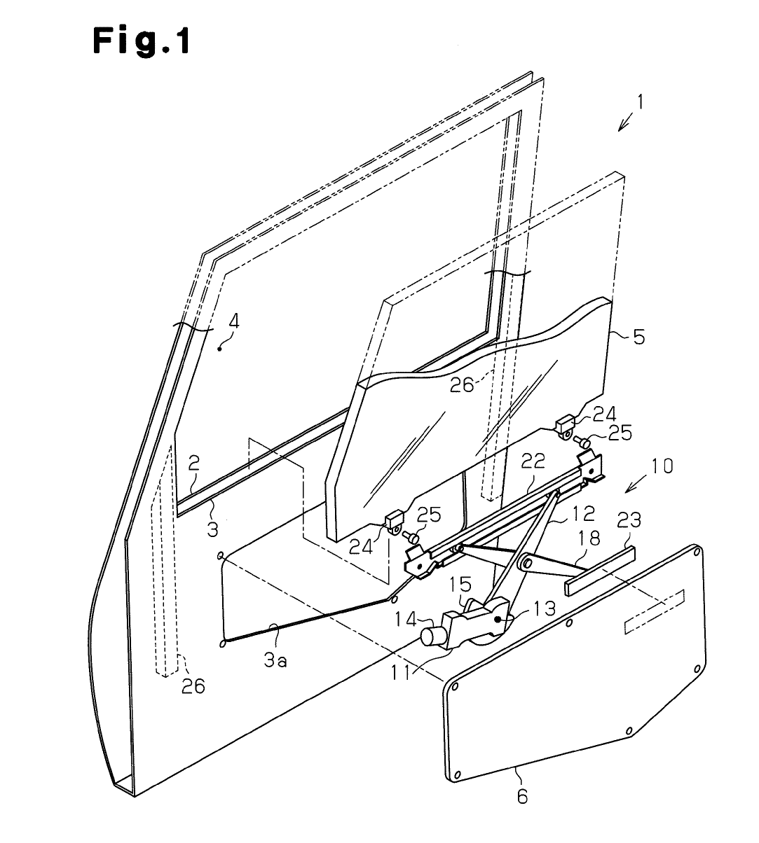

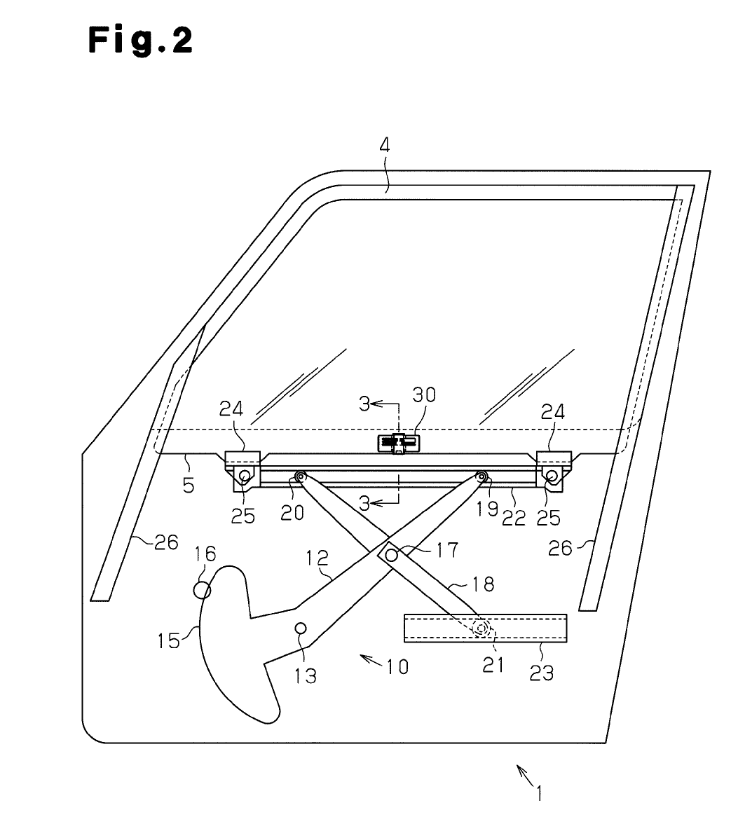

FIG. 1 is an exploded perspective view showing a right front door of a vehicle, and FIG. 2 is a schematic front view showing the right front door of FIG. 1.

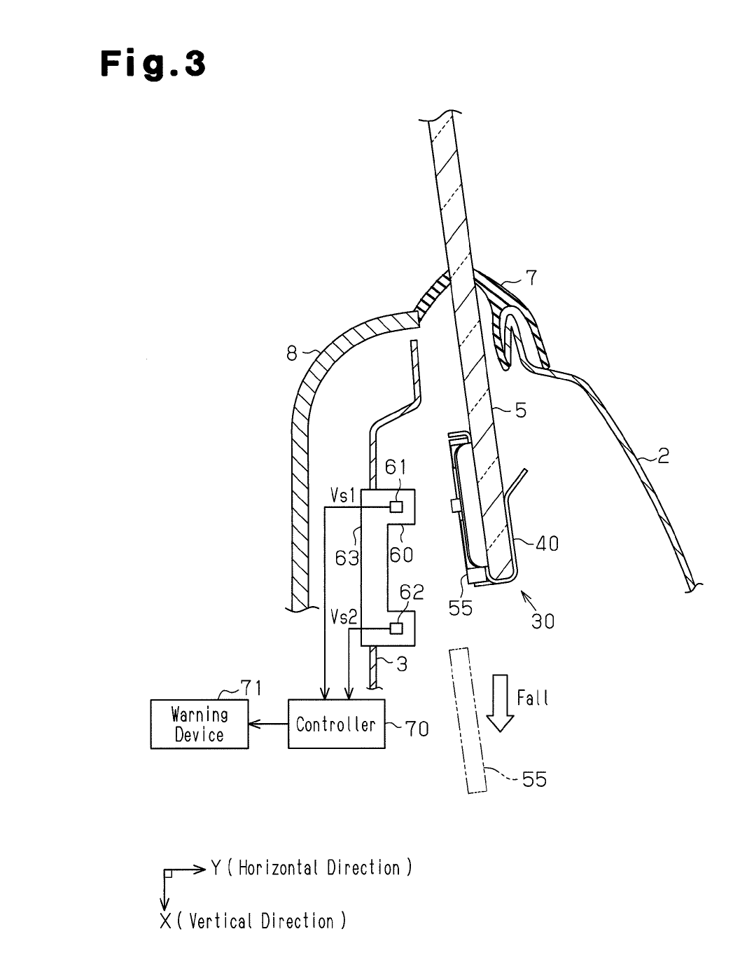

As shown in FIG. 1, a vehicle door 1 includes an outer panel 2 and an inner panel 3. A window glass 5, which is reinforced glass, is arranged between the outer panel 2 and the inner panel 3. The window glass 5 has a thickness of about 3.1 mm to 5.0 mm. A door rim 8 is attached to a vehicle interior side of the inner panel 3 (refer to FIG. 3).

A window regulator 10 that vertically moves the window glass 5 is accommodated in the vehicle door 1. In the present embodiment, an X-arm window regulator is used as the window regulator 10. A door component retaining cavity 3a is formed in the inner panel 3, and a modular panel 6 closes the door component retaining cavity 3a.

The X-arm window regulator 10 is supported by a base plate (fixed base) 11 on a vehicle exterior side surface of the modular panel 6. More specifically, the X-arm window regulator 10 includes a lift arm 12 having a pin 13, which is supported by the base plate 11. The base plate 11 is fixed to the vehicle exterior side surface of the modular panel 6. An electric drive unit 14 is fixed to the base plate 11. As shown in FIG. 2, the lift arm 12 includes a sector gear (driven gear) 15, which is formed integrally with the lift arm 12. The sector gear 15 pivots about the pin 13. The electric drive unit 14 of FIG. 1 includes a pinion 16 (see FIG. 2), which mates with the sector gear 15, and a motor (not shown), which drives the pinion 16.

The lift arm 12 includes an intermediate portion in the longitudinal direction as viewed in FIG. 2. An equalizer arm 18 is pivotally coupled to the intermediate portion of the lift arm 12 by a pin 17. Guide pieces (rollers) 19 and 20 are rotatably coupled to an upper end (distal end) of the lift arm 12 and an upper end (distal end) of the equalizer arm 18, respectively. A guide piece (roller) 21 is rotatably coupled to a lower end of the equalizer arm 18.

The guide piece 19 of the lift arm 12 and the guide piece 20 of the equalizer arm 18 are movably fitted to a window glass bracket 22. The guide piece 21 of the equalizer arm 18 is movably guided by an equalizer arm bracket (orientation maintaining rail) 23, which is fixed to the vehicle exterior side surface of the modular panel 6 of FIG. 1.

Two window glass holders 24 are fixed to the lower edge of the window glass 5. The window glass holders 24 are fixed in advance to the lower edge of the window glass 5. The window glass 5 together with the window glass holders 24 is inserted into a gap formed between the outer panel 2 and the inner panel 3 and then fixed to the window glass bracket 22 by bolts 25.

As shown in FIG. 2, the vehicle door 1 includes a pair of front and rear glass runs 26. The glass runs 26 are formed from a rubber material. The window glass 5 is movably supported by the two glass runs 26, which serve as rail members. In other words, the front and rear ends of the window glass 5 may be moved up and down guided by the glass runs 26.

When the electric drive unit 14 of FIG. 1 drives the pinion 16, the sector gear 15 pivots the lift arm 12 about the pin 13. As a result, the window glass bracket 22 (window glass 5) is lifted or lowered while remaining generally horizontal due to the equalizer arm 18, the guide pieces 19, 20, and 21, and the equalizer arm bracket 23. In this manner, the window glass 5 is lifted and lowered so that the window glass 5 freely opens and closes an opening 4 of the vehicle.

As shown in FIG. 3, a breakage detection device 30 for preventing unauthorized entry is arranged in the vehicle door 1. The breakage detection device 30 includes a clip 40 and a sensor unit 60.

As shown in FIG. 3, the window glass 5 is arranged between the outer panel 2 and the inner panel 3 in a state sealed by a weather strip 7. The door rim 8 is arranged at the vehicle interior side of the inner panel 3. The clip 40 is attached to the lower portion of the window glass 5.

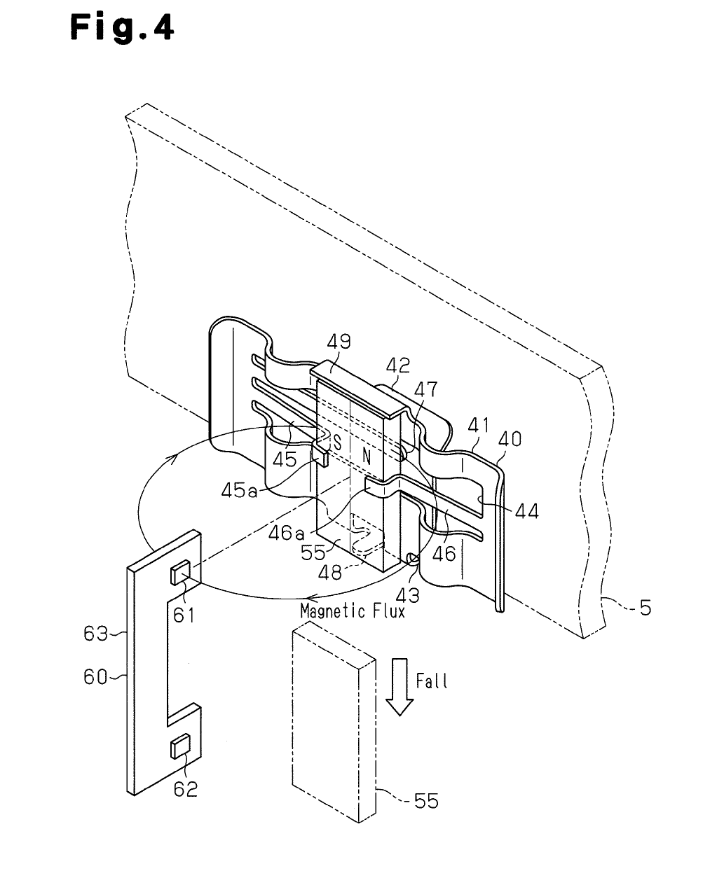

As shown in FIG. 4, the clip 40 is formed to hold a permanent magnet 55, which serves as a detected member, when the window glass 5 is unbroken and releases the magnet 55 when the window glass 5 is broken. The permanent magnet 55 has the shape of a tetragonal plate.

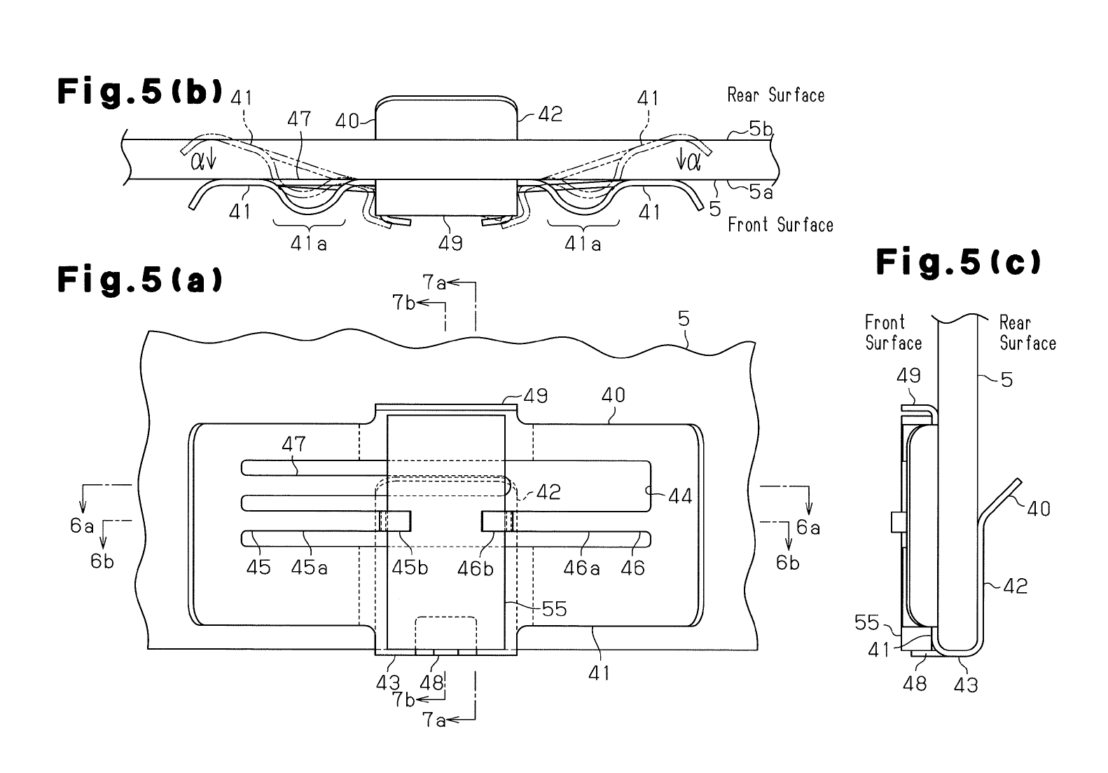

As shown in FIG. 5, the clip 40 is formed by bending a strip of a plate spring steel sheet, which extends laterally. The clip 40 includes first and second members 41 and 42, which face toward each other, and a bent portion (connecting portion) 43. The first member 41, which is located at the vehicle interior side, is rectangular and elongated in the lateral direction. The second member 42, which is located at the vehicle exterior side, is tetragonal and narrower than the first member 41. The bent portion 43 connects the laterally middle part of the first member 41 to the second member 42. The window glass 5 is arranged between the first member 41 and the second member 42, and the first member 41 and the second member 42 are urged toward the window glass 5, that is, toward each other.

As shown in FIG. 5, a rectangular through hole 44 extends through the first member 41 in the lateral direction. The second member 42 is located at a position corresponding to the middle part of the through hole 44. As shown in FIG. 5(b), the first member 41 has two lateral end portions forming two contact portions that come into contact with a first surface (front surface 5a) of the window glass 5. As shown in FIG. 5(a), the second member 42 is arranged at a location corresponding to the through hole 44 in the lateral direction of the first member 41 and contacts a second surface (rear surface 5b) of the window glass 5. Thus, the portion of the second member 42 that contacts the window glass 5 is arranged between the two contact portions of the first member 41 in the plane of the window glass 5. More specifically, before attaching the clip 40 to the window glass 5, the two end portions of the first member 41 are located at positions close to the second member 42 as shown by the double-dashed lines in FIG. 5(b). When the clip 40 is attached to the window glass 5, the two end portions of the first member 41 are deformed away from the second member 42 in an α-direction (toward the vehicle interior) as shown by the solid lines in FIG. 5(b) to hold the window glass 5 in cooperation with the second member 42.

In this manner, the first member 41 and the second member 42 are urged toward each other in a state contacting the window glass 5 at different positions in the plane of the window glass 5. That is, force is applied to the window glass 5 at different positions in the front surface 5a and rear surface 5b of the window glass 5. Further, the clip 40 holds (grips) a lower end portion of the window glass 5 with a predetermined force or greater.

As shown in FIGS. 4 and 7(b), a narrow projection 48 is formed on the lower part of the first member 41, and a wide projection 49 is formed on the upper part of the first member 41. The permanent magnet 55 is arranged on the projection 48, and the permanent magnet 55 has an upper surface located near the projection 49. That is, the permanent magnet 55 is located between the upper and lower projections 48 and 49, and the upper and lower projections 48 and 49 restrict movement of the permanent magnet 55.

Further, as shown in FIG. 5(b), the first member 41 includes load adjustment flexures 41a, which are curved.

As shown in FIGS. 4 and 5, the first member 41 includes two arms 45 and 46, which serve as a gripping portion for holding the permanent magnet 55. The two arms 45 and 46 cooperate with the first member 41 to grip the permanent magnet 55 when an openable window glass is unbroken and release the permanent magnet 55 when the window glass is broken.

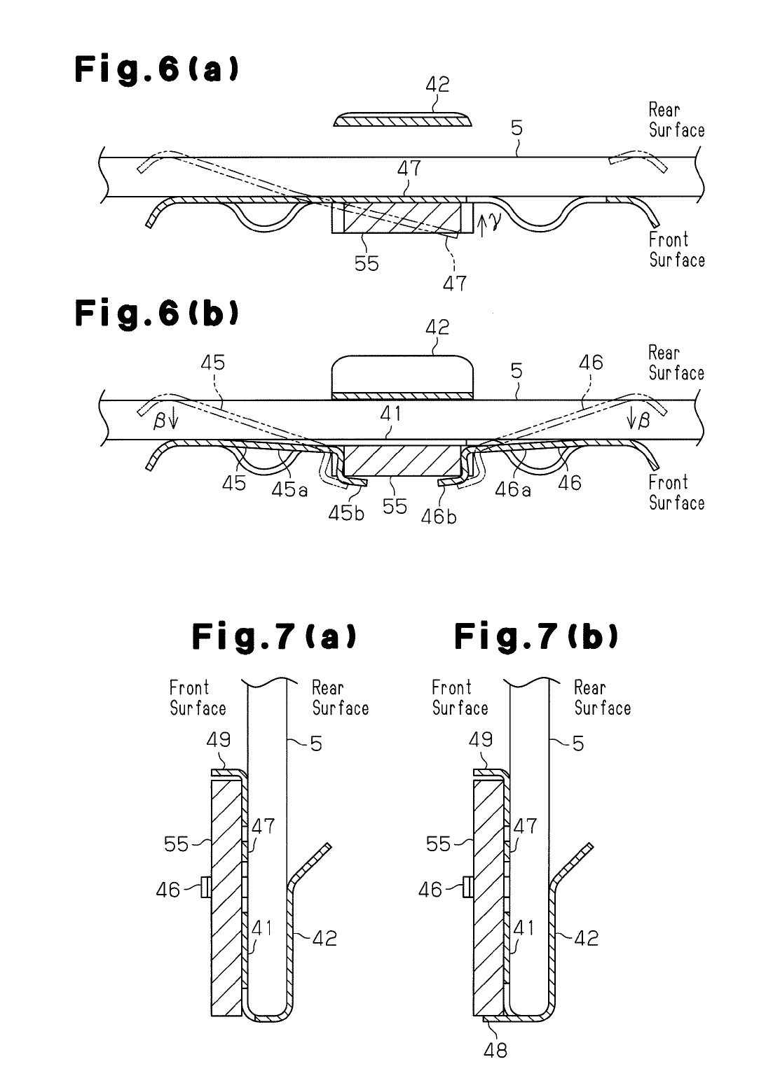

In detail, the two arms 45 and 46 extend from the lateral side walls defining the through hole 44 toward the middle part of the clip 40. The arms 45 and 46 are each a linearly extending strip and have a distal portion that is bent twice, as shown in FIG. 6(b). In a state in which the plane on one side of the permanent magnet 55 is in contact with the first member 41, the arms 45 and 46 hold the permanent magnet 55 with magnet engagement portions 45a and 46a, which engage with the edges of the plane on the other side of the permanent magnet 55. This restricts movement of the permanent magnet in the lateral direction and toward the interior of the vehicle. As shown by the double-dashed lines in FIG. 6(b), before the clip 40 is attached to the window glass 5, the arms 45 and 46 are located near the second member 42. When the clip 40 is attached to the window glass 5, the arms 45 and 46 are deformed in a β-direction (direction toward the vehicle interior), as shown by the solid lines in FIG. 6(b). This fixes two sides of the magnet 55 from the vehicle interior side with the magnet engagement portions 45a and 46a.

Further, as shown in FIGS. 4 and 5, the first member 41 includes an arm 47 serving as an urging portion. The arm 47 cooperates with the first member 41 to pop out the permanent magnet 55 when the openable window glass breaks. In detail, the arm 47 extends from the left side wall defining the through hole 44 toward the middle part of the clip. The arm 47 is a linearly extending strip. The double-dashed lines in FIG. 6(a) show the location of the arm 47 before the clip 40 is attached to the window glass 5. Prior to the attachment, the distal side of the arm 47 is located at a position spaced apart from the second member 42. Then, when the clip 40 is attached to the window glass 5, as shown by the solid lines in FIG. 6(a), the arms 47 deform in a γ-direction (toward the rear surface). Accordingly, the arms 47 urges the rear surface of the permanent magnet 55 toward the vehicle interior side.

As shown in FIG. 3, the sensor unit 60 is fixed to the inner panel 3. Here, the vertical direction is defined as the X-direction, and the horizontal direction is defined as the Y-direction. The permanent magnet 55 is movable in the X-direction, that is, allowed to fall down.

The sensor unit 60 includes a first magnetic sensor (magnetic sensor element) 61, a second magnetic sensor (magnetic sensor element) 62, and a substrate 63. The first magnetic sensor 61 and the second magnetic sensor 62 are arranged on the substrate 63 and spaced apart in the vertical direction. Specifically, the magnetic sensors 61 and 62 are spaced apart by about 4 cm. When the window glass 5 is fully closed, the first magnetic sensor 61 is arranged at the same height as the magnet 55 and spaced apart from the magnet 55 by a predetermined distance in the Y-direction. The second magnetic sensor 62 is located below the first magnetic sensor 61. Accordingly, the permanent magnet 55 passes by the front of the second magnetic sensor 62 when the magnet 55 falls.

The magnetic sensors 61 and 62 output signals corresponding to the distance from the magnet 55. In the state of FIG. 3, the first magnetic sensor 61 is arranged at the same height as the magnet 55 and thus has a high output voltage. Further, the second magnetic sensor 62 is arranged below the first magnetic sensor 61 and thus has a low output voltage. Hall ICs may be used as the magnetic sensors 61 and 62.

In this manner, the magnet 55 is arranged at a position spaced apart from the magnetic sensors 61 and 62 and movable relative to the magnetic sensors 61 and 62. The magnetic sensor 61 and 62 detect the intensity of the magnetic field of the magnet 55. This allows for detection of the location of the magnet 55 relative to the magnetic sensors 61 and 62.

As shown in FIG. 4, the magnet 55 is magnetized so that the right half is the N pole and the left half is the S pole. The magnetic sensors 61 and 62 are arranged so that their magnetic detection surfaces are orthogonal to the magnetized surface (front surface) of the magnet 55. The magnetic flux extending from the N pole to the S pole of the magnet 55 is detected at the magnetic detection surface of the magnetic sensors 61 and 62.

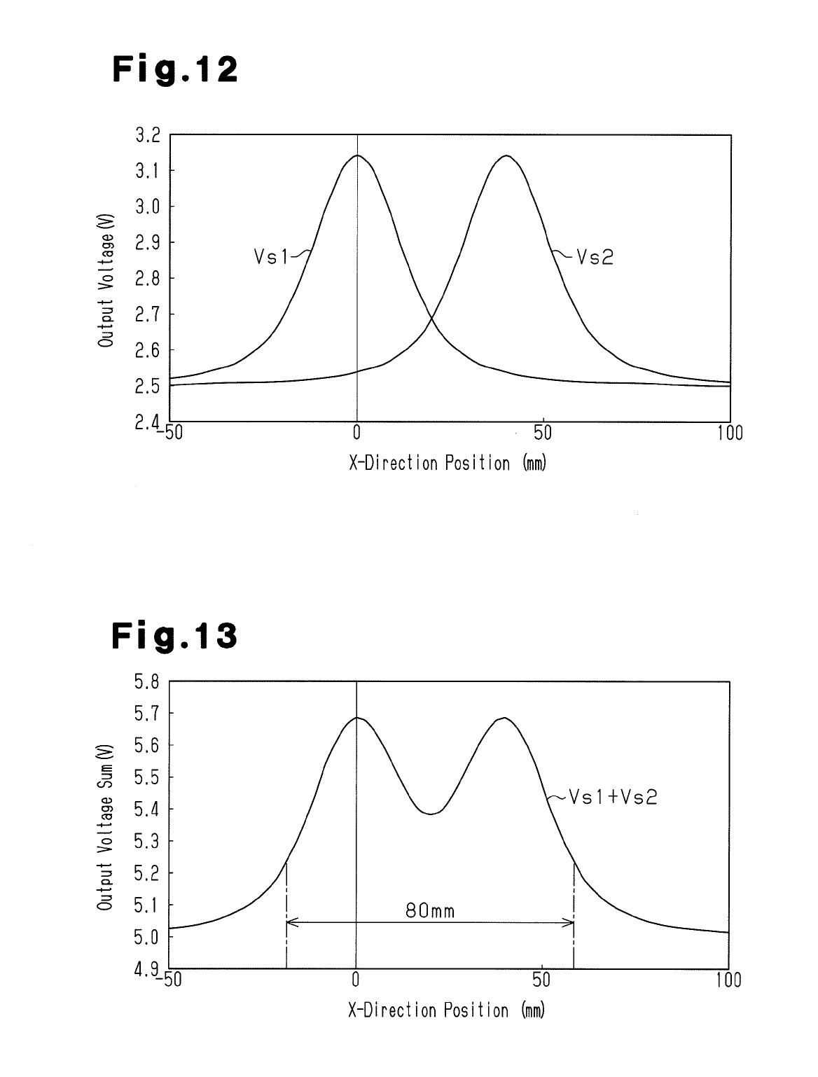

As shown in FIG. 3, the magnetic sensors 61 and 62 are connected to a controller 70. The controller 70 includes an A/D converter and a microcomputer. The A/D converter converts analog data output from the magnetic sensors 61 and 62 into signals of digital data (output voltages Vs1 and Vs2), which is retrieved by the microcomputer. The microcomputer adds the output voltages (digital values) of the magnetic sensors 61 and 62 to obtain a sum Vn (=Vs1+Vs2) of the output signals shown in FIG. 13. This obtains a signal having a high output level in a wider range (80 mm in FIG. 13) compared to when solely using the output voltage Vs1 or Vs2 of each of the magnetic sensors 61 and 62 shown in FIG. 12. As a result, the location of the magnet 55 may be detected over a wide range. As shown in FIG. 3, a warning device 71 is connected to the controller 70.

The operation of the clip 40 when the window glass 5 breaks will now be discussed.

FIGS. 5, 6, and 7 show the clip 40 in a normal state, or when the window glass 5 is unbroken. The window glass 5 may be fully closed or slightly open (for a few centimeters) when the vehicle occupant leaves the vehicle. In this case, the controller 70 detects the position of the window glass 5 from the sensor output level of FIG. 13. When the parking brake is operated and the window glass 5 is fully closed or slightly open, the controller 70 sets a glass breakage detection mode. In this state, the clip 40 arranged at the end portion of the window glass 5 holds the end portion of the window glass 5. More specifically, the elastic force of the clip 40 holds the window glass 5 between the first member 41 and the second member 42. In this state, the first member 41 and the second member 42 are urged toward each other in a state contacting the window glass 5 at different positions in the plane of the window glass 5. Further, when the window glass 5 is unbroken, the two arms 45 and 46 cooperate with the first member 41 to hold the magnet 55. In the unbroken state, the magnet 55 is located in front of the first magnetic sensor 61 of the sensor unit 60.

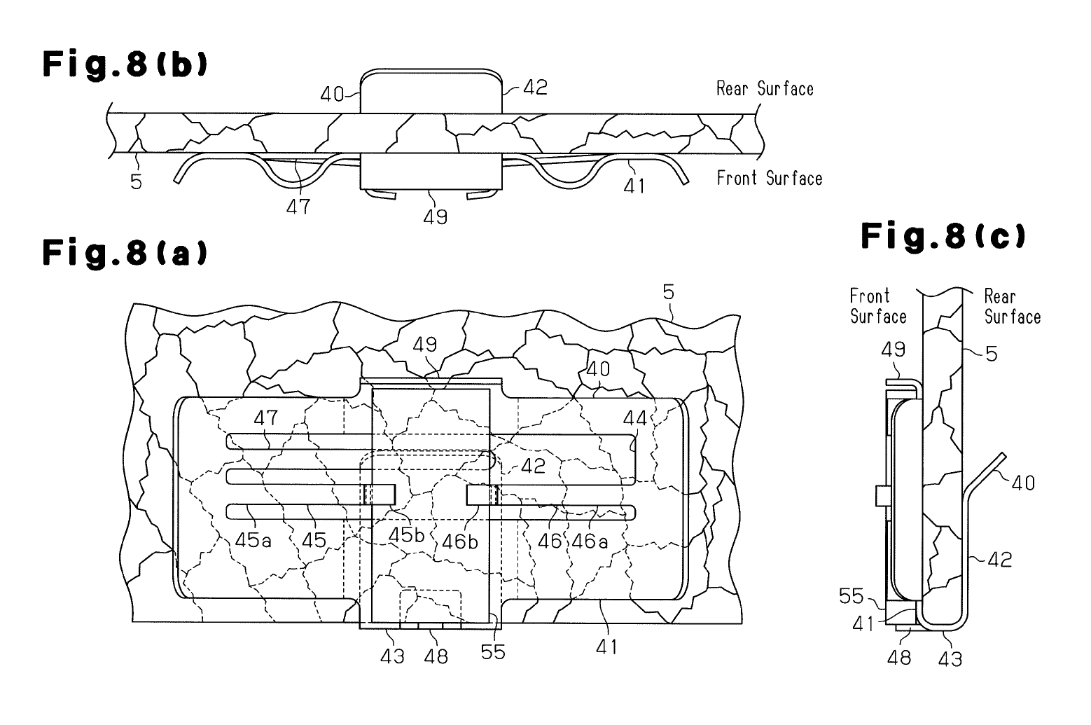

In this state, breakage of the window glass 5 lowers the strength of the window glass. That is, partial breakage of the window glass 5, which is reinforced glass, forms cracks throughout the entire window glass 5 as shown in FIG. 8 and drastically decreases the strength.

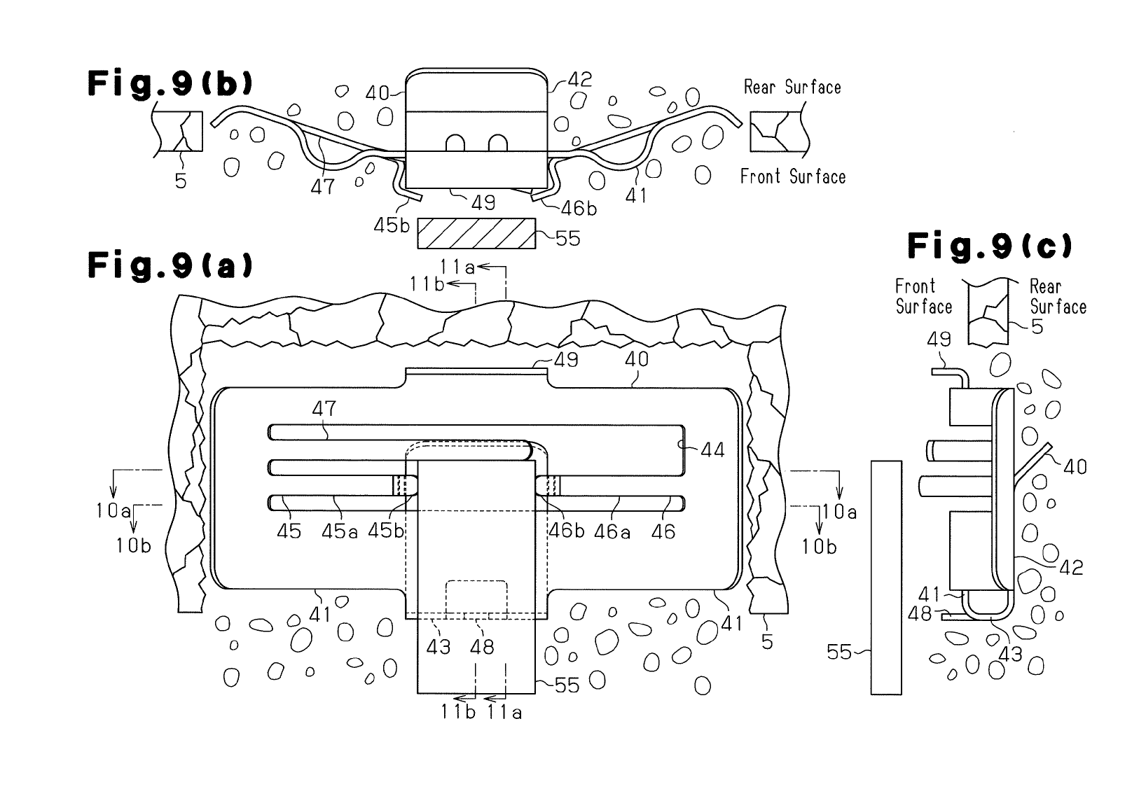

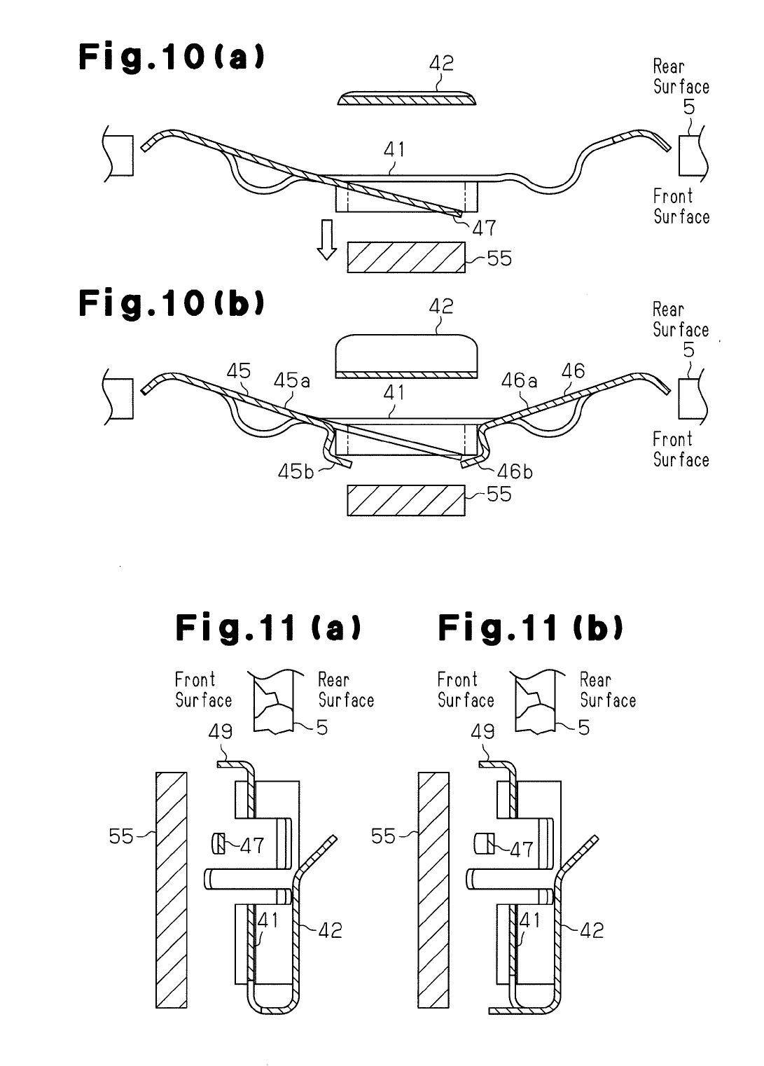

As the strength decreases, the clip 40 shatters with its holding force the end portion (lower end portion) of the window glass 5, as shown in FIGS. 9, 10, and 11. In other words, the clip 40 completely shatters part of the window glass 5, which is formed from reinforced glass, with its elastic force. More specifically, force is applied to different positions in the window glass 5 at the front surface 5a and rear surface 5b of the window glass 5. This ensures shattering of the end portion of the window glass 5 when the window glass 5 is broken (strength decreased). As shown in FIG. 10(b), this pivots the arms 45 and 46 and moves the magnet engagement portions 45a and 46a at the distal ends of the arms 45 and 46 thereby releasing the engagement (holding) of the permanent magnet 55. As a result, as shown in FIG. 10(a), the arm 47 that urges the rear surface of the permanent magnet 55 toward the vehicle interior side causes the permanent magnet 55 to pop out toward the front and fall (pushed out and dropped). In further detail, the elastic force of the arm 47 pushes toward the front and drops the permanent magnet 55 against the magnetic force (attraction force) of the permanent magnet 55 and the first member 41.

In this manner, the arm 47 serving as the urging portion causes the permanent magnet 55 to pop out and fall when the window glass is broken.

In the sensor unit 60, prior to the breakage of the window glass 5, the sum Vn (=Vs1+Vs2) of the output signals of the magnetic sensors 61 and 62 has a value that is greater than or equal to a predetermined threshold value. However, when the window glass 5 breaks and the magnet 55 falls, the sum of the output voltages of the magnetic sensors 61 and 62 is no longer greater than or equal to the predetermined threshold value. Thus, the falling of the permanent magnet 55 is detected. As a result, breakage of the window glass 5 is detected.

As described above, reinforced glass has a feature in which partial breakage of the glass forms cracks entirely in the glass and thereby drastically decreases the strength. This feature is used to minimize detection failure and erroneous detection of the breakage of the window glass 5.

Further, when the window glass 5 is not located at the fully-closed position as shown in FIG. 2, the magnet 55 also falls when the window glass 5 breaks. This allows the breakage detection device 30 to detect breakage of the window glass 5. In detail, in the prior art detection device (patent document 1), movement of the window glass is detected when the window glass is fully closed. Thus, when the window glass is not located at the fully-closed position, breakage of the window glass cannot be detected. In contrast, the breakage detection device 30 of the present embodiment allows for breakage detection of the window glass 5 when the window glass 5 is slightly open for ventilation or the like.

Moreover, in the clip 40 of FIG. 5, the first member 41 and the second member 42 are urged toward each other in a state in contacting the window glass 5 at different positions in the plane of the window glass 5. Thus, force is applied to the window glass at different positions in the front surface 5a and rear surface 5b of the window glass 5. This ensures that the end portion of the window glass 5 is shattered when the window glass 5 breaks and thereby ensures breakage detection of the window glass 5.

Referring to FIG. 3, when breakage of the window glass 5 is detected as the sensor unit 60 detects the falling of the permanent magnet 55 from the output voltages of the magnetic sensors 61 and 62, the controller 70 activates the warning device 71 and issues a warning.

The above-discussed embodiment has the advantages described below.

(1) The clip 40 includes the first member 41 and the second member 42, which are bent and arranged facing toward each other. In a state in which the first member 41 and the second member 42 are in contact with the window glass 5 at different positions in the plane of the window glass 5, the first member 41 and the second member 42 are urged toward each other by their elastic forces. When the window glass 5 breaks, the clip 40 changes the arrangement state of the permanent magnet 55, which serves as a detected member, relative to the window glass 5. This ensures that the breakage detection device 30 detects breakage of the window glass 5 even when the window glass 5 holds together without being completely shattered.

Further, in the prior art (patent document 1), the regulator must be modified. This may lower the reliability and quality. However, the structure of the present embodiment does not require the regulator to be modified and thus has superior reliability and quality. Moreover, the structure of the prior art is complicated. This may increase costs. However, the present embodiment has a simple structure. This allows for the breakage detection device 30 to be relatively inexpensive.

(2) The window glass 5 freely opens and closes an opening of a vehicle. Thus, breakage of the window glass 5 may be detected even when the window glass 5 is not located at the fully-closed position.

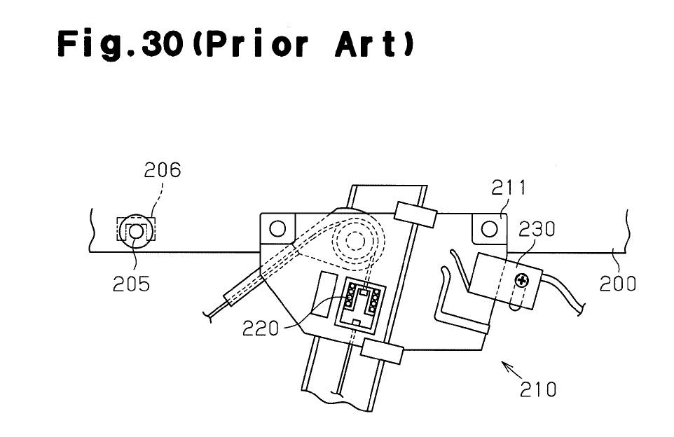

In detail, in the prior art detection device shown in FIG. 30, the structure detects only displacement of the window glass 200 in the closing direction from the fully-closed position. Thus, when the window glass 200 is not located at the fully-closed position, that is, when the window glass 200 is slightly open for ventilation, the detection device cannot detect breakage of the window glass 200. In contrast, in the present embodiment, breakage of the window glass 5 is detected even when the window glass 5 is not located at the fully-closed position.

(3) The first member 41 includes the gripping portion (arms 45 and 46), which serve as a means for changing the arrangement state of the magnet 55 relative to the window glass 5 when the window glass 5 breaks. The arms 45 and 46 cooperate with the first member 41 to hold the magnet 55 when the window glass 5 is unbroken and release the magnet 55 when the window glass 5 is broken. In this structure, window glass breakage is detected from the falling of the permanent magnet 55. This allows for breakage of the window glass 5 to be detected even when the falling of the clip 40 is interfered with, for example, when the clip 40 gets caught somewhere in the vehicle body or the clip 40 remains on the window glass 5. That is, the magnet 55 is held only when fixed by the clip 40, and the magnet 55 is released when glass breakage causes the deformed clip 40 to return to its original shape (the shape prior to attachment to the window glass) thereby causing the magnet 55 to fall, which is detected by the sensors 61 and 62.

(4) The first member 41 includes an urging portion (arm 47). When the openable window glass breaks, the arm 47 cooperates with the first member 41 to pop out the magnet 55. Thus, window glass breakage is detected by popping out the magnet 55. That is, the arm 47 pushes the magnet 55 from the side with elastic force. This separates and drops the magnet 55 from the clip 40.

(5) The detected member is the magnet 55. Thus, the magnetic force of the magnet 55 attracts the clip 40 when the openable window glass is in a non-broken state.

(6) The gripping portion is the two arms 45 and 46. Thus, the gripping portion is formed by a simple structure.

(7) The urging portion is the arm 47. Thus, the urging portion is formed by a simple structure.

The present embodiment is not limited to the foregoing description and may take, for example, the forms described below.

(A) An X-arm window regulator is used for the window regulator. Instead, a cable window regulator may be used.

(B) The driver is not limited to a motor and may be manually driven by a vehicle occupant.

(C) The breakage detection device 30 is applied to the right front door of a vehicle. However, the window glass breakage detection device 30 may be applied to other side doors, a rear door, and an openable glass roof, which is arranged in the roof.

(D) The sensor unit 60 includes the two magnetic sensors 61 and 62 but may include just one magnetic sensor.

(E) A magnetic sensor is used as the sensor unit 60. However, an infrared sensor may be used as the sensor, and the clip 40 may include an infrared reflective member (mirror) facing toward the infrared sensor. More specifically, an infrared reflective mirror may be used in lieu of the magnet 55 of FIG. 5, and an infrared sensor may be used in lieu of the magnetic sensor unit 60. The infrared sensor emits infrared rays and receives reflection light from the reflective mirror to detect when the mirror falls based on the existence of the reflection light. That is, the breakage detection device 30 does not have to be of a magnetic detection type and may be of a light reflection detection type.

(F) The clip 40 does not necessarily have to be arranged on the lower end portion of the window glass 5. For example, the clip 40 may be arranged at a lower portion of a side surface of the window glass 5. It is only required that the clip 40 be arranged in the vehicle door 1 on the end portion of the window glass at an unnoticeable position.

(G) The arm 47 that serves as the urging portion may be eliminated. In particular, for a light reflection detection type device, the arm 47 may be eliminated.

(H) Instead of an openable window glass, the clip 40 may be attached to a fixed type (fitting type) window glass.

(I) Instead of a plate spring steel sheet, the clip 40 may be formed from other elastic materials, such as a carbon fiber material.

A second embodiment will now be discussed by mainly describing the differences from the first embodiment.

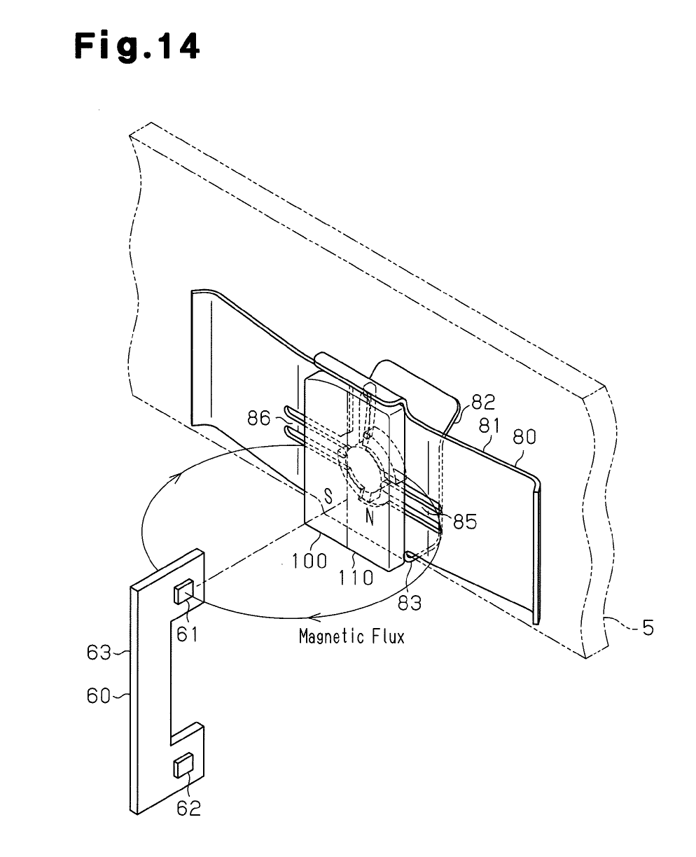

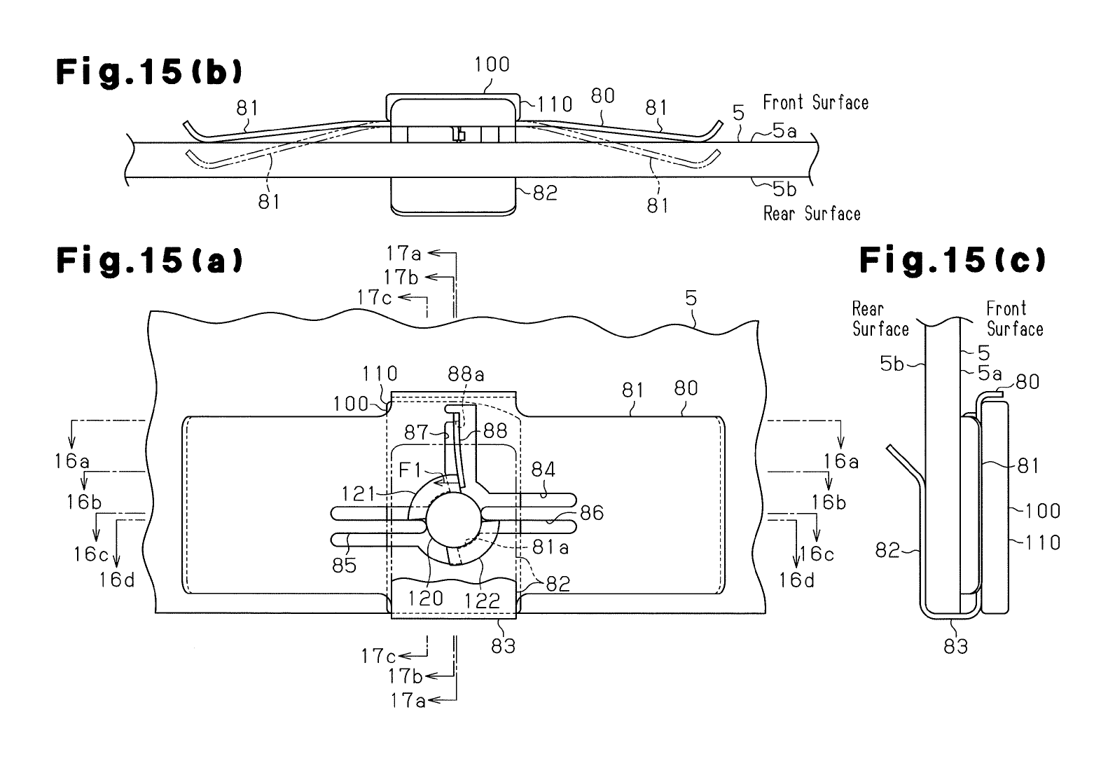

As shown in FIGS. 14 and 15, a clip 80 is formed by bending a strip of a plate spring steel sheet. The clip 80 includes first and second members 81 and 82, which face toward each other, and a bent portion (connecting portion) 83. The first member 81, which is located at the vehicle interior side, is rectangular and elongated in the lateral direction. The second member 82, which is located at the vehicle exterior side, is tetragonal and narrower than the first member 81. The bent portion 83 connects the laterally middle part of the first member 81 to the second member 82. The window glass 5 is arranged between the first member 81 and the second member 82, and the first member 81 and the second member 82 are urged toward the window glass 5, that is, toward each other.

Referring to FIG. 15, the first member 81 has two lateral end portions (two contact portions) that come into contact with the first surface (front surface 5a) of the window glass 5, as shown in FIG. 15(b). Further, the second member 82 contacts the second surface (rear surface 5b) of the window glass 5. Thus, the portion of the second member 82 that contacts the window glass 5 is arranged between the two contact portions of the first member 81 in the plane of the window glass 5. More specifically, before attaching the clip 80 to the window glass 5, the two end portions of the first member 81 are located at positions close to the second member 82 as shown by the double-dashed lines in FIG. 15(b). When the clip 80 is attached to the window glass 5, the two end portions of the first member 81 are deformed away from the second member 82 toward the vehicle interior, as shown by the solid lines in FIG. 15(b) to hold the end portion of the window glass 5 in cooperation with the second member 82.

In this manner, the first member 81 and the second member 82 are urged toward each other by their elastic forces in a state contacting the window glass 5 at different positions in the plane of the window glass 5. That is, force is applied to the window glass 5 at different positions in the front surface 5a and rear surface 5b of the window glass 5. Further, the clip 80 holds (grips) the lower end portion of the window glass 5 with a predetermined force or greater.

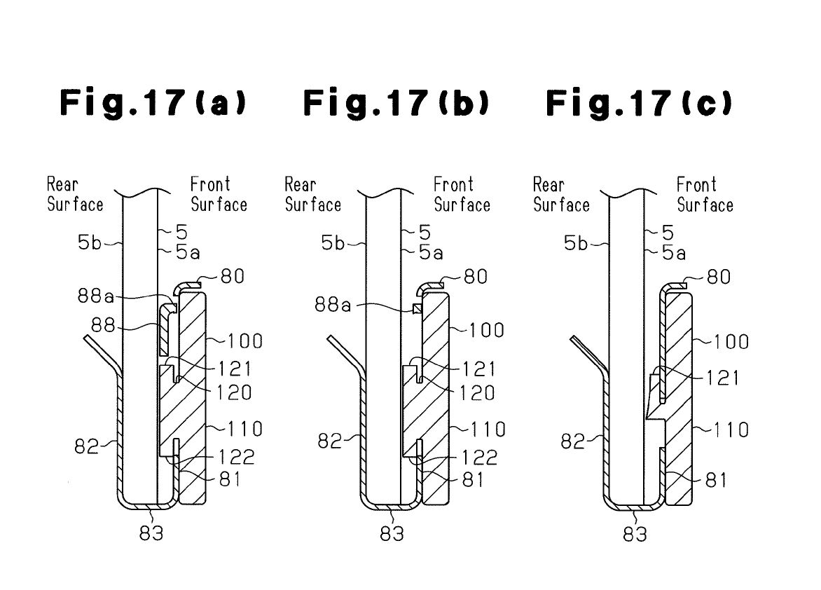

A permanent magnet 100 is formed by a plastic magnet (bond magnet). The permanent magnet 100 has a main body 110, which has the shape of a rectangular plate. As shown in FIG. 14, the permanent magnet 100 is magnetized so that the right half is the N pole and the left half is the S pole. As shown in FIG. 17(b), a cylindrical portion 120 extends from the rear surface of the main body 110. The cylindrical portion 120 extends through a through hole 81a (refer to FIG. 15(a)) formed in the first member 81 of the clip 80. As a result, the clip 80 rotatably supports the magnet 100. Further, as shown in FIGS. 15(a) and 17(b), arcuate stoppers 121 and 122 are formed on the periphery of the distal part of the cylindrical portion 120. The stoppers 121 and 122 each extend about the cylindrical portion 120 over a range of 90 degrees. Further, the two stoppers 121 and 122 are arranged in symmetry to each other about the cylindrical portion 120.

As shown in FIG. 15(a), a through hole 87 extends in the vertical direction through the laterally middle part of the first member 81 of the clip 80. A flap 88 extends downward from a portion of the first member 81 that defines a left upper end portion of the through hole 87. The flap 88 is a linearly extending strip having a top portion 88a connected to (bent with) the first member 81. The flap 88 has a distal end that contacts a side surface of the stopper 121 of the magnet 100. The elasticity of the flap 88 urges the stopper 121 toward the left, as viewed in FIG. 15(a), with force F1. This applies force to the magnet 100 in the counterclockwise direction.

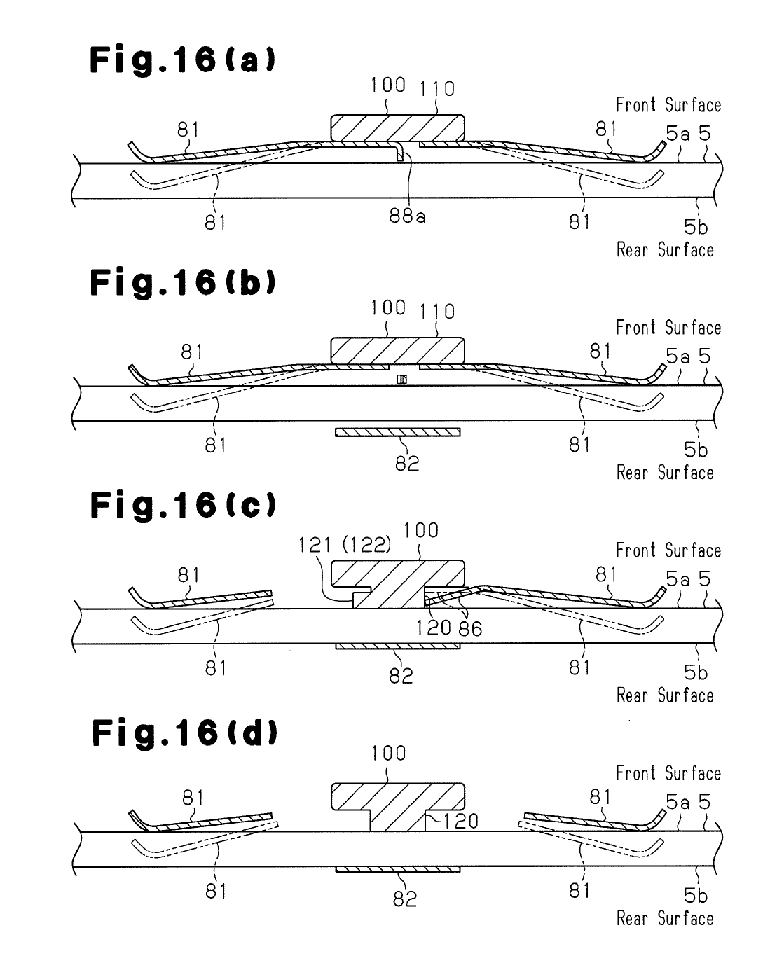

Further, as shown in FIG. 15(a), a rectangular through hole 84 extends through the first member 81 in the lateral direction. The first member 81 includes arms 85 and 86. The arms 85 and 86 extend toward each other from the lateral side walls defining the through hole 84. The arm 86 has a distal end that contacts a side surface of the stopper 122 of the magnet 100 (refer to FIG. 16(c)). In the same manner, the arm 85 has a distal end that contacts a side surface of the stopper 121 of the magnet 100. This prevents further rotation of the magnet 100 and holds the magnet 100 at a normal position. In other words, the arms 85 and 86 cooperate with the first member 81 to hold the magnet 100 at the normal position when the window glass is unbroken and release the magnet 100 from the normal position when the window glass is broken.

As described above, the flap 88 urges the magnet 100 in a rotation direction with its elasticity. The flap 88 forms a means for changing the arrangement state of the magnet 100 when the window glass 5 breaks.

The operation when the window glass 5 breaks will now be described.

When attaching the clip 80 to the window glass 5, the cylindrical portion 120 of the magnet 100 is inserted into the through hole 81a in the first member 81 of the clip 80. Then, the magnet 100 is rotated. This deforms the distal side of the flap 88 thereby applying the force F1 (refer to FIG. 15(a)) in the rotation direction to the magnet 100 and holding the magnet 100 at a normal position with the arms 85 and 86.

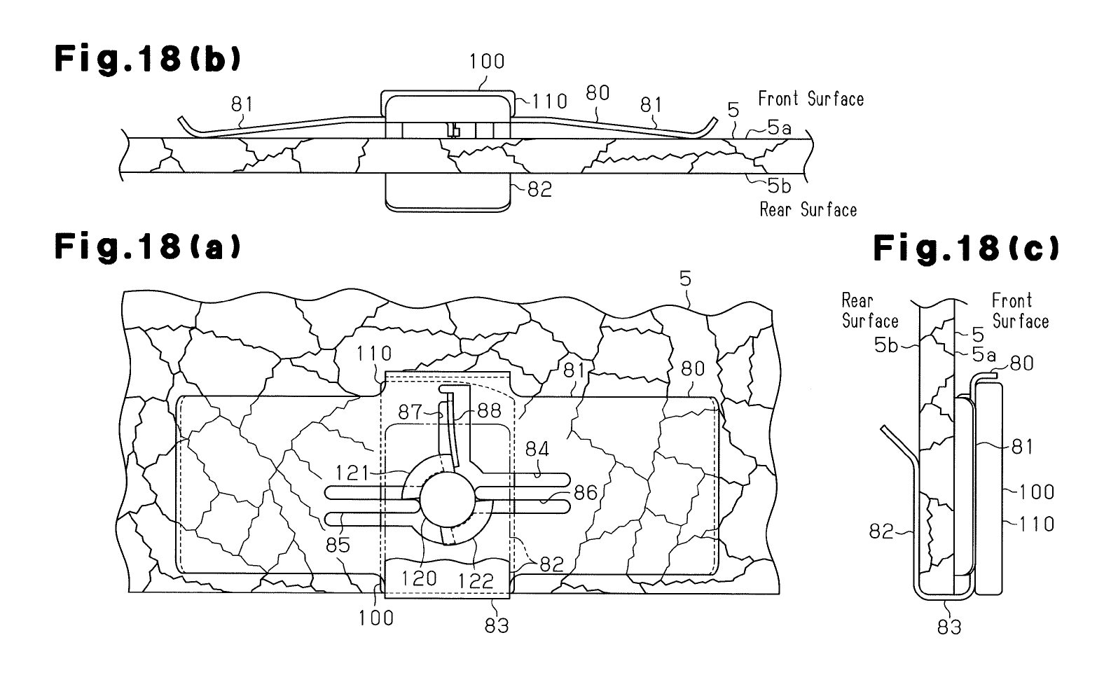

When the window glass 5 partially breaks, cracks form throughout the entire window glass 5 as shown in FIG. 18 and drastically decrease the strength.

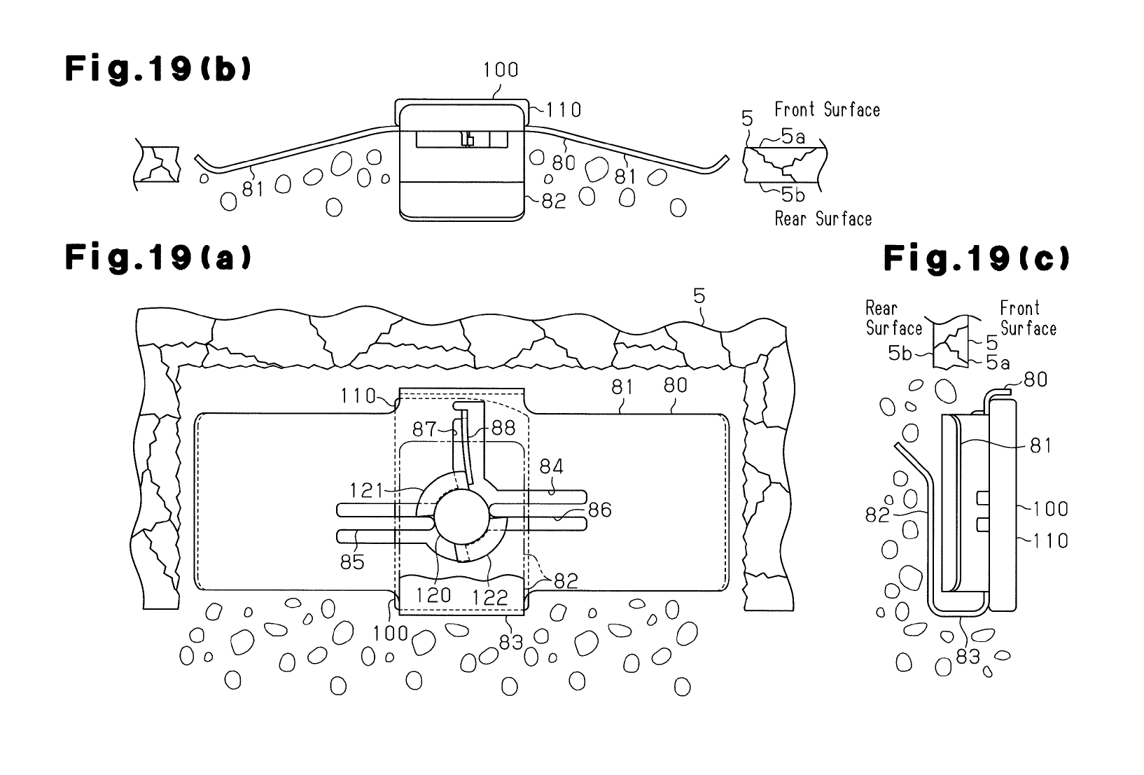

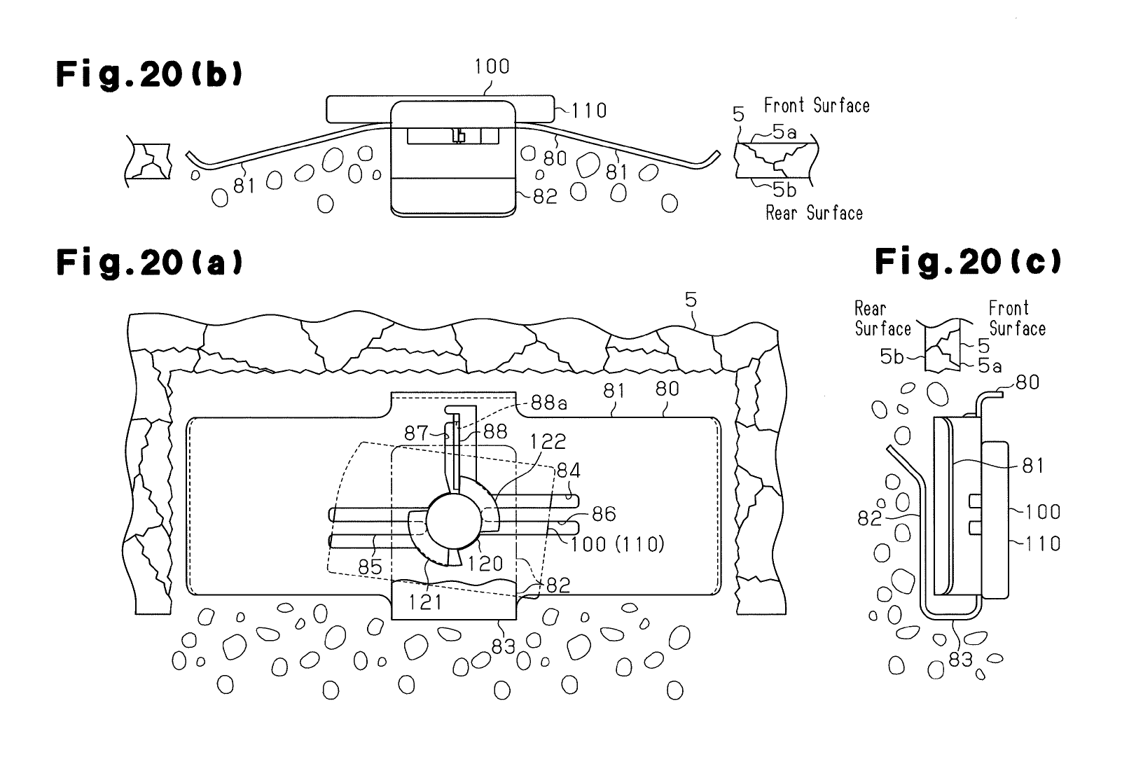

As the strength decreases, the clip 80 shatters with its holding force the end portion (lower end portion) of the window glass 5, as shown in FIG. 19. This displaces the first member 81 of the clip 80 towards the rear as shown by the double-dashed line in FIG. 16(b). The displacement of the first member 81 of the clip 80 displaces and separates the arms 85 and 86 of the clip 80 as shown by the double-dashed lines in FIG. 16(c) from the side surfaces of the stoppers 121 and 122 such that the magnet 100 becomes rotatable. Accordingly, the flap 88 produces rotation force that rotates the magnet 100 by about 90 degrees in the counterclockwise direction as shown in FIG. 20. This decreases the magnetic force at the magnetic detection surfaces of the magnetic sensors 61 and 62. For example, the sum of the output voltages in FIG. 13 decreases to, for example, about 5.1 volts. As a result, in the sensor unit 60, prior to the breakage of the window glass 5, the sum (=Vs1+Vs2) of the output voltages of the magnetic sensors 61 and 62 has a value that is greater than or equal to a predetermined threshold value. However, when the window glass 5 breaks and the magnet 55 rotates by about 90 degrees, the sum of the output voltages of the magnetic sensors 61 and 62 is no longer greater than or equal to the predetermined threshold value. Thus, the rotation of the permanent magnet 55 is detected. As a result, breakage of the window glass 5 is detected.

As described above, when the window glass 5 is unbroken, the arms 85 and 86 abut against the stoppers 121 and 122 magnet 100 and fixes (holds) the magnet 100 at the normal position. However, when the window glass 5 is broken, the arms 85 and 86 are separated from the side surfaces of the stoppers 121 and 122 and the elastic force of the flap 88 rotates the magnet 100. This changes the magnetic force that reaches the magnetic sensors 61 and 62. Breakage of the window glass 5 is detected from the change in magnetic force.

The present embodiment has the advantages described below.

(1) The clip 80 rotatably supports the magnet 100, which serves as a detected member, and includes a rotating portion that rotates the magnet 100 when the window glass 5 breaks and serves as a means for changing the arrangement state of the magnet 100 when the window glass 5 breaks. This allows for breakage of the window glass 5 to be detected from the rotation of the magnet 100.

(2) The rotating portion is the flap 88, which urges the magnet 100 with its elasticity in the rotation direction. This rotates the magnet 100 with a simple structure.

A third embodiment will now be discussed by mainly describing the differences from the second embodiment.

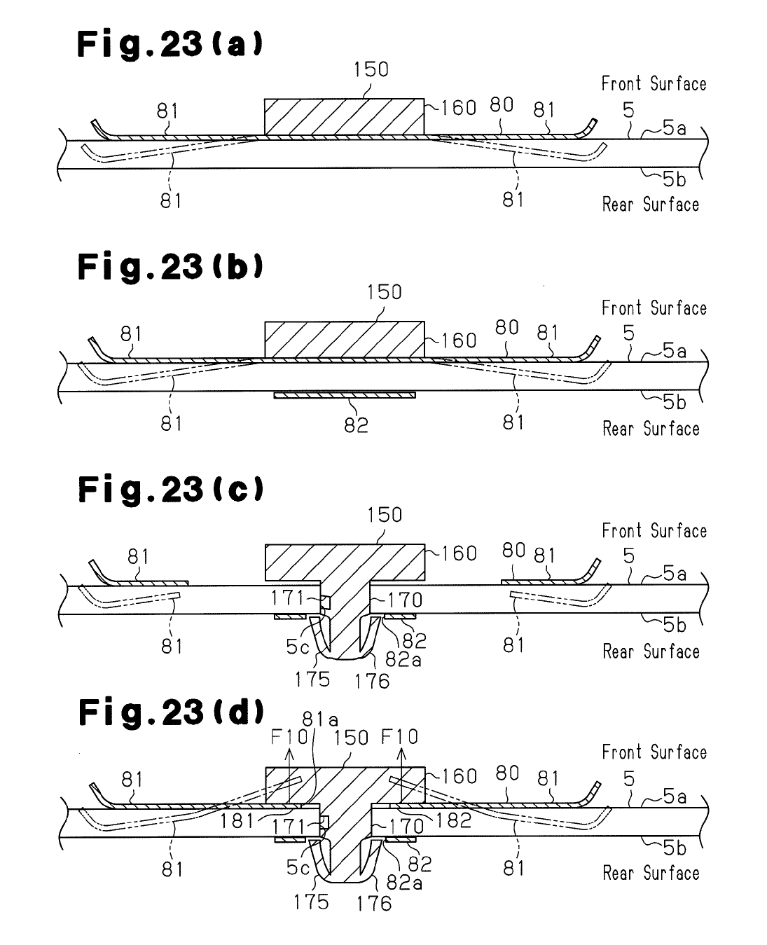

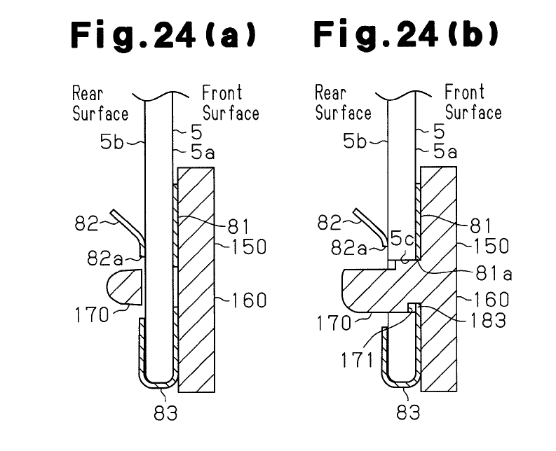

In the same manner as the second embodiment, in the present embodiment, a permanent magnet 150 is rotated. However, the angle of rotation is 180 degrees (in the second embodiment, about 90 degrees). Thus, the rotation mechanism is different. As shown in FIGS. 23(c), 23(d), and 24(b), a bore 5c extends through the window glass 5. The bore 5c is circular.

The permanent magnet 150 is also formed by a plastic magnet (bond magnet). The permanent magnet 150 has a main body 160, which has the shape of a rectangular plate. As shown in FIGS. 23(c), 23(d), 24(b), and 25, a cylindrical portion 170 extends from the rear middle part of the main body 160. The cylindrical portion 170 extends in a direction perpendicular to the glass plane of the window glass 5, that is, the front surface 5a and the rear surface 5b. The cylindrical portion 170 extends through the through hole 81a (refer to FIG. 23(d)) formed in the first member 81 of the clip 80 and the bore 5c of the window glass 5 and reaches the rear surface 5b of the window glass 5. Further, at the side of the rear surface 5b of the window glass 5, stoppers 175 and 176 are formed on the distal portion of the cylindrical portion 170. The stoppers 175 and 176, which are wider than the bore 5c of the window glass 5, prevent the magnet 150 from falling out of the bore 5c. As a result, the clip 80 and the window glass 5 rotatably support the magnet 150, which serves as a detected member. A through hole 82a is formed in the second member 82 of the clip 80 at a location corresponding to the stoppers 175 and 176 of the magnet 150 so that the stoppers 175 and 176 of the magnet 150 do not contact the second member 82 of the clip 80.

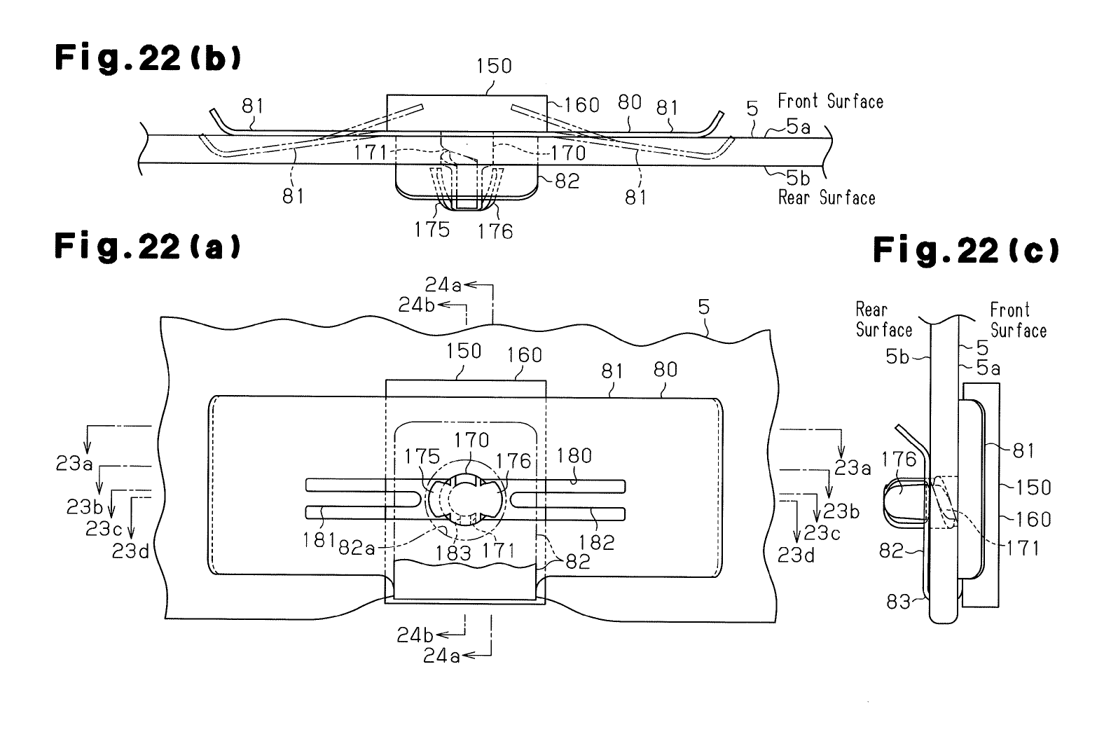

Further, as shown in FIG. 22(a), a rectangular through hole 180 extends through the first member 81 of the clip 80 in the lateral direction. Arms 181 and 182 linearly extend toward each other from the lateral side walls defining the through hole 180. Referring to FIG. 23(d), the distal side of the arms 181 and 182 apply force F10 to the rear surface of the main body 160 of the magnet 100 and urge the main body 160 toward the vehicle interior side. In this manner, the two arms 181 and 182 each urge the magnet 150 with its elasticity in a direction perpendicular to the glass plane of the window glass 5.

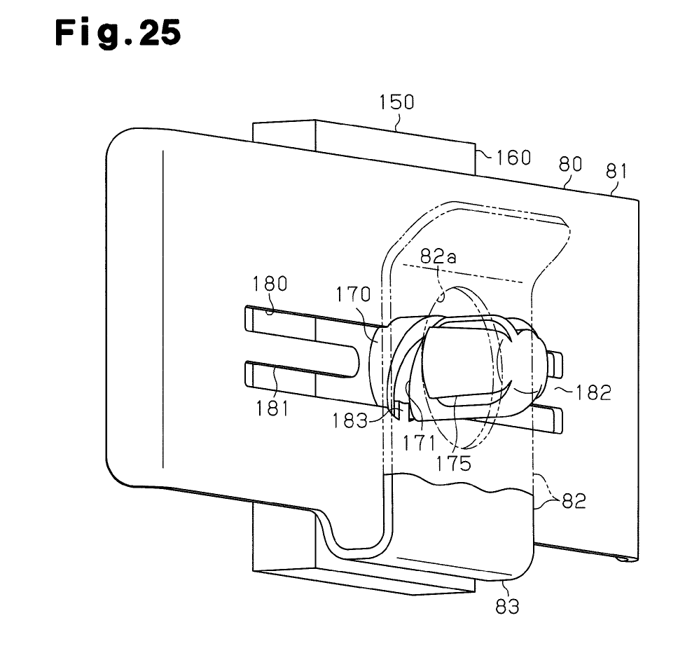

As shown in FIGS. 23(c), 23(d), 24(b), and 25, a spiral groove 171 is formed in the peripheral surface of the cylindrical portion 170 of the magnet 150. The spiral groove 171 extends over a range of 180 degrees. The spiral groove 171 is engaged with an engagement projection 183 as shown in FIG. 25. The engagement projection 183 projects from the first member 81 of the clip 80 at a portion located below a middle part of the through hole 180. When the magnet 150 moves toward the vehicle interior side as the arms 181 and 182 urge the rear surface of the magnet 150 toward the vehicle interior side, the magnet 150 is rotated by 180 degrees while the engagement projection 183 remains engaged along the spiral groove 171. The engagement projection 183 and the two arms 181 and 182 form a means for changing the arrangement state of the magnet 150 when the window glass 5 breaks.

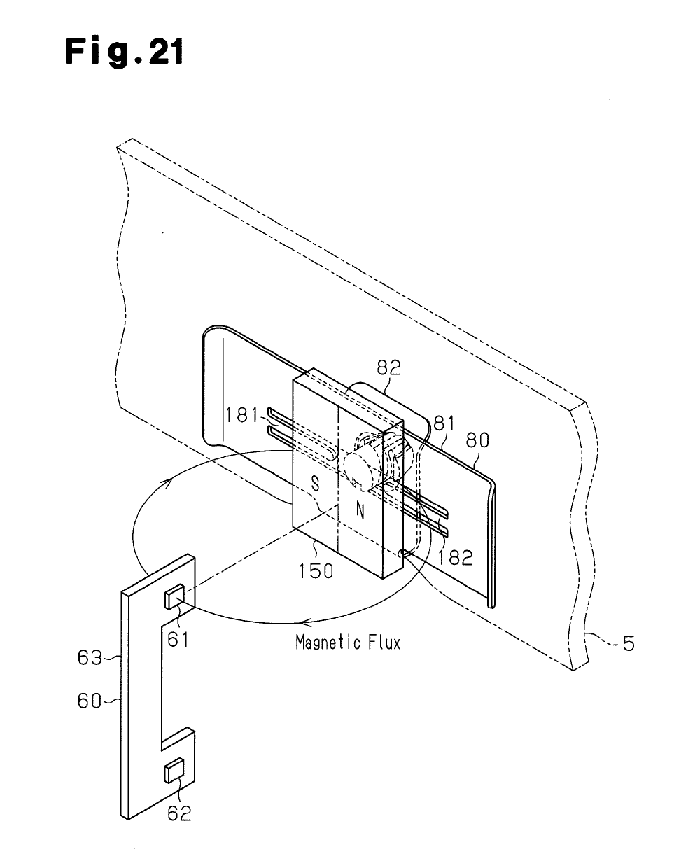

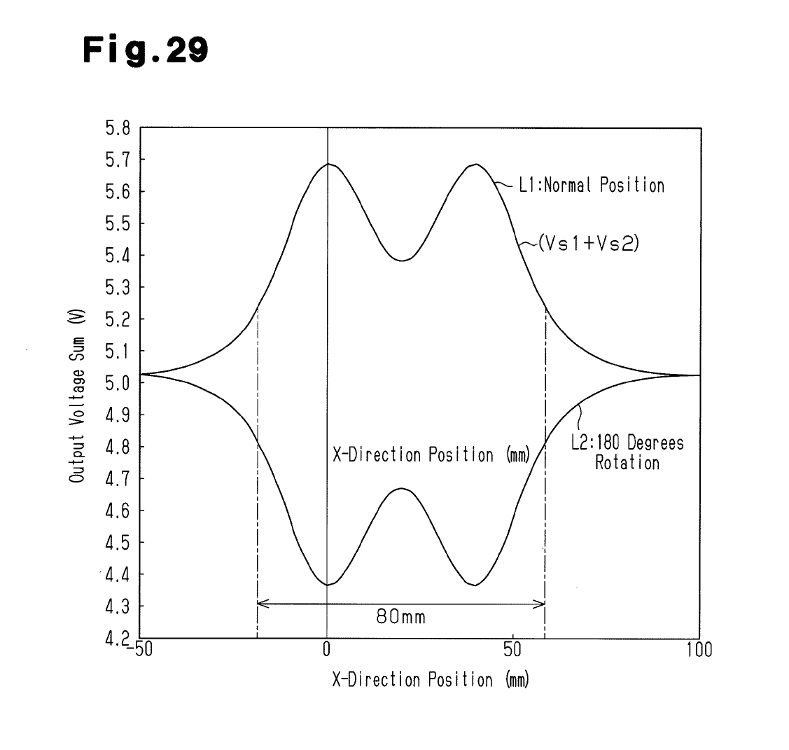

In FIG. 29, L1 represents the characteristics when the magnet 150 is located at the normal position as shown in FIGS. 21, and L2 represents the characteristics when the magnet 150 is rotated by 180 degrees from the normal position. The characteristic lines L1 and L2 are shaped so as to be upside down from each other. When the magnet 150 is rotated by 180 degrees from the normal position, the output voltage levels of the sensors 61 and 62 decrease drastically.

The operation of the clip 80 when the window glass 5 breaks will now be described.

When attaching the clip 80 to the window glass 5, the glass 5 is held in the clip 80. Further, in a state in which the diameters of the stoppers 175 and 176 are reduced against their elastic forces, the cylindrical portion 170 of the magnet 150 is inserted into the bore 5c from the front surface 5a of the window glass 5. During the insertion, the magnet 150 is rotated so that the engagement projection 183 of the clip 80 engages with the spiral groove 171 in the cylindrical portion 170 of the magnet 150. When the stoppers 175 and 176 of the magnet 150 passes through the bore 5c of the window glass 5 and are arranged at the side of the rear surface 5b of the window glass 5, the diameters of the stoppers 175 and 176 are enlarged. This prevents the magnet 150 from falling out of the bore 5c of the window glass 5. In this state, the arms 181 and 182 apply force to the magnet 150 directed from the vehicle exterior side toward the vehicle interior side.

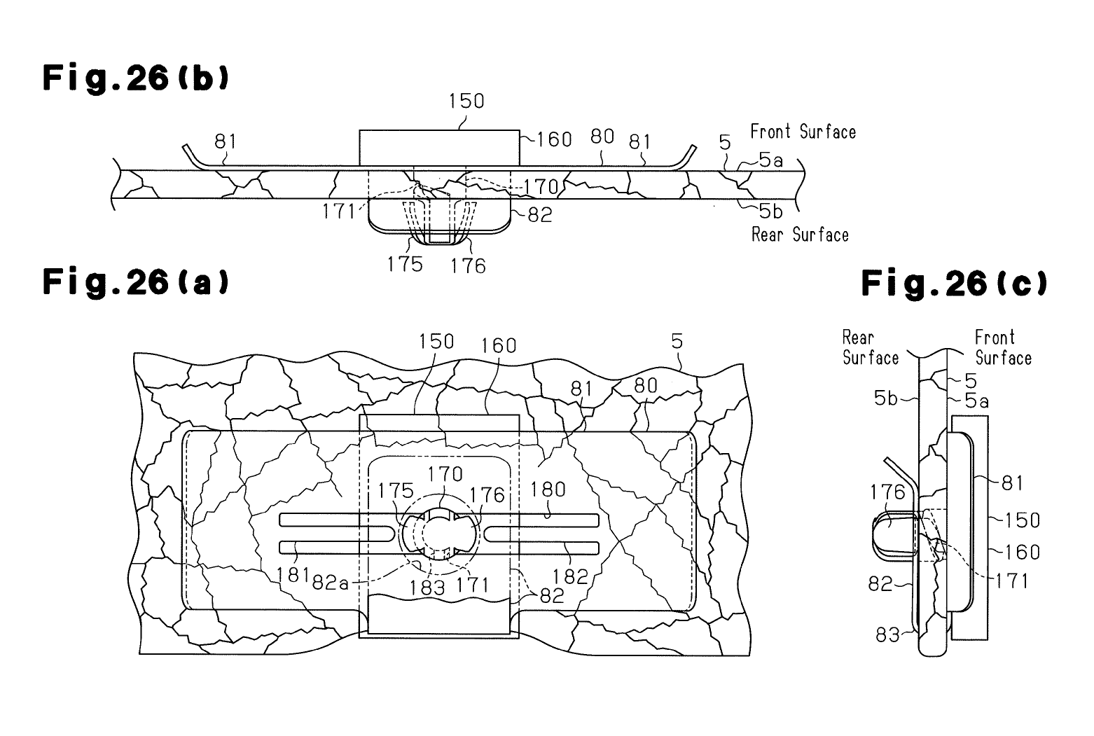

When the window glass 5 partially breaks, cracks form throughout the entire window glass 5 as shown in FIG. 26 and drastically decrease the strength.

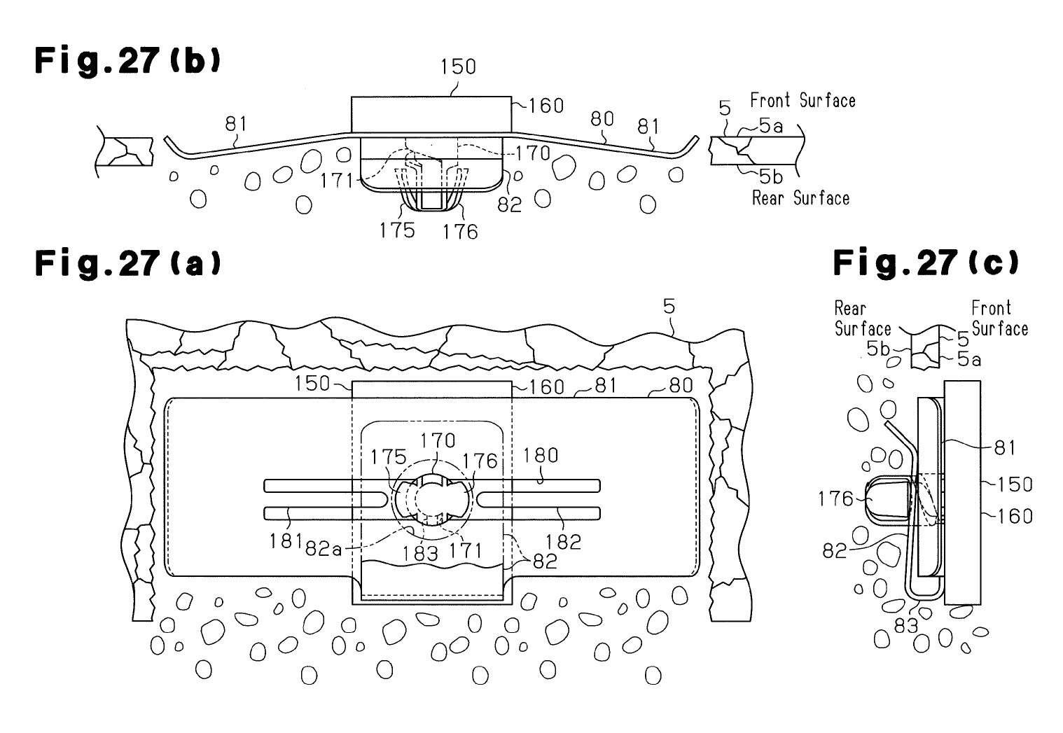

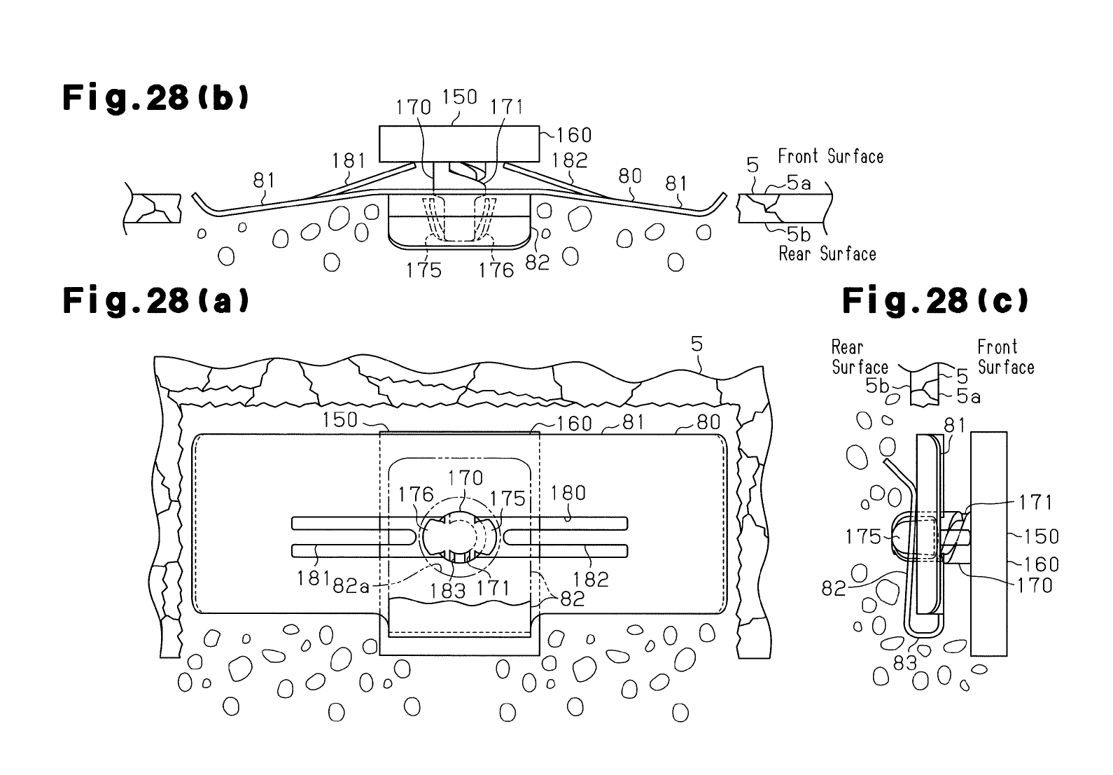

As the strength decreases, the clip 80 shatters with its holding force the end portion (lower end portion) of the window glass 5, as shown in FIG. 27. As a result, the two arms 181 and 182 move the magnet 150 toward the vehicle interior side in a state in which the engagement projection 183 is engaged with the spiral groove 171. Here, as the engagement projection 183 slides along the spiral groove 171, the magnet 150 rotates by 180 degrees as shown in FIG. 28.

In the sensor unit 60, prior to the breakage of the window glass 5, the sum (=Vs1+Vs2) of the output voltages of the magnetic sensors 61 and 62 has a value that is greater than or equal to a predetermined threshold value. However, when the window glass 5 breaks and the magnet 55 rotates by about 180 degrees, the sum of the output voltages of the magnetic sensors 61 and 62 is no longer greater than or equal to the predetermined threshold value. Thus, the rotation of the permanent magnet 55 is detected. As a result, breakage of the window glass 5 is detected. More specifically, as shown in FIG. 29, when the magnet 150 rotates 180 degrees from the normal position, the sum of the sensor outputs changes greatly.

The present embodiment has the advantages described below.

A rotating portion that rotates the magnet 150 when the window glass 5 breaks includes the engagement projection 183 and the two arms 181 and 182. The engagement projection 183 engages with the spiral groove 171 formed in the peripheral surface of the cylindrical portion 170, which extends in a direction perpendicular to the glass plane of the window glass 5, on the magnet 150 that serves as a detected member. The two arms 181 and 182 urge the magnet 150 with its elasticity in a direction perpendicular to the glass plane of the window glass 5. When the window glass 5 breaks in a state in which the engagement projection 183 is engaged with the spiral groove 171, the two arms 181 and 182 move the magnet 150 in a direction perpendicular to the glass plane of the window glass 5. The sliding of the engagement projection 183 on the spiral groove 171 in this state rotates the magnet 150. This allows for the magnet 150 to be greatly rotated. That is, the magnet 150 is rotated by about 90 degrees in the second embodiment. However, the magnet 150 is rotated by 180 degrees in the present embodiment. This increases the changes in the sensor outputs and further ensures that breakage of the window glass 5 is detected.

Each of the second and third embodiments may be practiced as described above in paragraphs (A) to (I).

1. A clip for detecting window glass breakage used to detect breakage of a window glass when the arrangement state of a detected member relative to a window glass of a vehicle changes, the clip for detecting window glass breakage comprising:
first and second members bent toward each other to hold an end portion of the window glass;
wherein when the window glass is unbroken, the first member and the second member contact the window glass at different positions in a plane of the window glass and are urged toward each other in a state in which the window glass is arranged therebetween; and
when the window glass is broken, the first member and the second member are elastically deformed so as to shatter the end portion of the window glass and thereby change the arrangement state of the detected member relative to the window glass.

2. The clip for detecting window glass breakage according to claim 1, wherein the window glass is capable of freely opening and closing an opening of the vehicle.

3. The clip for detecting window glass breakage according to claim 1, wherein the first member and the second member are formed by bending a plate spring steel sheet.

4. The clip for detecting window glass breakage according to claim 1, further comprising:
a gripping portion that cooperates with the first member to hold the detected member when the window glass is unbroken and release the detected member to change the arrangement state of the detected member when the window glass is broken.

5. The clip for detecting window glass breakage according to claim 4, wherein the gripping portion is formed of two arms.

6. The clip for detecting window glass breakage according to claim 4, further comprising:
an urging portion that cooperates with the first member when the window glass breaks to pop out the detected member.

7. The clip for detecting window glass breakage according to claim 6, wherein the urging portion is an arm.

8. The clip for detecting window glass breakage according to claim 1, further comprising:
a rotating portion that rotatably supports the detected member and rotates the detected member to change the state of the detected member when the window glass is broken.

9. The clip for detecting window glass breakage according to claim 8, wherein the rotating portion is a flap that urges with its elasticity the detected member in a rotation direction.

10. The clip for detecting window glass breakage according to claim 8, wherein the detected member includes a cylindrical portion extending in a direction perpendicular to a glass plane of the window glass, with a spiral groove being formed in a peripheral surface of the cylindrical portion;
the rotating portion includes an engagement projection that engages with the spiral groove and two arms that urge the detected member with its elasticity in a direction perpendicular to the glass plane of the window glass;
wherein when the window glass breaks, the two arms move the detected member in a direction perpendicular to the glass plane of the window glass in a state in which the engagement projection is engaged with the spiral groove so that the detected member rotates while the engagement projection moves along the spiral groove.

11. The clip for detecting window glass breakage according to claim 1, wherein the detected member is a magnet.

12. The clip for detecting window glass breakage according to claim 2, further comprising:
a gripping portion that cooperates with the first member to hold the detected member when the window glass is unbroken and release the detected member to change the arrangement state of the detected member when the window glass is broken.

13. The clip for detecting window glass breakage according to claim 12, wherein the gripping portion is formed of two arms.

14. The clip for detecting window glass breakage according to claim 12, further comprising:
an urging portion that cooperates with the first member when the window glass breaks to pop out the detected member.

15. The clip for detecting window glass breakage according to claim 14, wherein the urging portion is an arm.

16. The clip for detecting window glass breakage according to claim 3, further comprising:
a gripping portion that cooperates with the first member to hold the detected member when the window glass is unbroken and release the detected member to change the arrangement state of the detected member when the window glass is broken.

17. The clip for detecting window glass breakage according to claim 2, further comprising:
a rotating portion that rotatably supports the detected member and rotates the detected member to change the state of the detected member when the window glass is broken.

18. The clip for detecting window glass breakage according to claim 17, wherein the rotating portion is a flap that urges with its elasticity the detected member in a rotation direction.

19. The clip for detecting window glass breakage according to claim 17, wherein the detected member includes a cylindrical portion extending in a direction perpendicular to a glass plane of the window glass, with a spiral groove being formed in a peripheral surface of the cylindrical portion;
the rotating portion includes an engagement projection that engages with the spiral groove and two arms that urge the detected member with its elasticity in a direction perpendicular to the glass plane of the window glass;
wherein when the window glass breaks, the two arms move the detected member in a direction perpendicular to the glass plane of the window glass in a state in which the engagement projection is engaged with the spiral groove so that the detected member rotates while the engagement projection moves along the spiral groove.

20. The clip for detecting window glass breakage according to claim 3, further comprising:
a rotating portion that rotatably supports the detected member and rotates the detected member to change the state of the detected member when the window glass is broken.
